(19) United States
(12) Patent Application Publication
(10) Pub. No.: US 2020/0336035 A1
(43) Pub. Date: Oct. 22, 2020

(54) INSULATION OF SUB-CONDUCTORS OF A DYNAMOELECTRIC MACHINE

(71) Applicant: Siemens Aktiengesellschaft, 80333 München (DE)

(72) Inventors: ROBIN BRENNER, Kirchham (DE); HARRY LÜTKE, Nürnberg (DE); NORBERT SCHÖNBAUER, Bad Füssing (DE)

(73) Assignee: Siemens Aktiengesellschaft, München (DE)

(21) Appl. No.: 16/956,279

(22) PCT Filed: Dec. 13, 2018
(86) PCT No.: PCT/EP2018/084667

§ 371 Date: Jun. 19, 2020

(30) Foreign Application Priority Data
Dec. 20, 2017 (EP) 17208914.6
Mar. 23, 2018 (EP) 18163675.4

(51) Int. Cl. H02K 3/40; H02K 3/34; H02K 15/10

(52) U.S. Cl. CPC H02K 3/40; H02K 15/105; H02K 3/34

(57) ABSTRACT

An electrical conductor has two or more sub-conductors which are insulated from each other by virtue of the fact that the sub-conductors have merely one insulation layer with respect to the one or more adjacent sub-conductors. Each sub-conductor or the conductor is surrounded by a bandage of polyester fibers and glass fibers or only glass fibers.

The invention relates to the insulation of sub-conductors of a conductor, a coil with conductors, a stator of a dynamoelectric machine with coils, a dynamoelectric machine with a stator and methods for producing conductors, coils and stators of dynamoelectric machines.

The winding systems in dynamoelectric machines, for example electric motors or generators, are constructed from individual coils. The coils have one or more conductors, which are insulated from one another. In particular, these individual sub-conductors of a conductor must have so-called winding insulation, which as a rule is only designed for comparatively low voltages of maximum 80V. Such sub-conductor insulation is provided, for example, by insulating varnish applied to conductors.

From experience, the sub-conductors are made of copper or aluminum with the sub-conductors being insulated all-round with varnish. Alternatively, the sub-conductors can also have all-round tape insulation.

The disadvantage here is that, when the sub-conductors of the conductors of a coil are arranged in the slot of a dynamoelectric machine, the thicknesses of the winding insulations are added together, thereby reducing the available copper fill factor in the slot.

Accordingly, the invention is based on the object of providing sufficient insulation of sub-conductors of a conductor, plus a coil with conductors and a winding system of a stator or a stator segment of a dynamoelectric machine, in order, by means of a simple production of a winding system while simultaneously increasing the copper or aluminum fill factor in the slots of the stator of a dynamoelectric machine, to obtain comparably greater efficiency of the dynamoelectric machine.

The object set is achieved by an electrical conductor comprising two or more sub-conductors, wherein these sub-conductors are insulated from each other by virtue of the fact that the sub-conductors have only one insulation layer with respect to the adjacent sub-conductor(s) of this conductor, wherein each sub-conductor or the conductor is surrounded by a bandage made of polyester fibers and glass fibers or glass fibers only.

The object set is also achieved by a coil of a winding system of a machine with at least one conductor according to the invention.

The object set is also achieved by a stator or a stator segment of a dynamoelectric machine with a winding system arranged in slots of the stator or the stator segment with individual electrically mutually contactable coils in each phase, wherein the coil has one or more conductors, each of which being constructed from a plurality of sub-conductors, wherein these sub-conductors are insulated from one another by virtue of the fact that the sub-conductors have only one insulation layer with respect to the adjacent sub-conductor(s) of their conductor at least in the respective slot, wherein each sub-conductor is surrounded by a polyester glass fiber bandage or only a glass fiber bandage.

The object set is also achieved by a dynamoelectric machine with a stator according to the invention or stator segment according to the invention.

The object set is also achieved by a method for producing a conductor, by the following steps:
providing bare sub-conductors,
partially applying an insulation layer to the sub-conductors, in particular with a predeterminable covering of the sub-conductor of 30 to 70% when viewed in the circumferential direction,
arranging the sub-conductors of this conductor such that, with respect to the adjacent sub-conductor(s) of this conductor, a sub-conductor has only one insulation layer.

The object set is also achieved by a method for producing a coil from conductors according to the invention, wherein contouring bodies against which the conductors rest are used to shape the coil.

The object set is also achieved by a method for producing a winding system of a stator or stator segment by the following steps:
providing a magnetically conductive main body, in particular a laminated core, with substantially axially extending slots,
inserting coils prefabricated according to the invention or conductors according to the invention into these slots in accordance with a predeterminable winding scheme in order to obtain a winding system of the stator or the stator segment,
impregnating the winding system into the slots.

According to the invention, the individual sub-conductors of a conductor are only partially insulated when viewed in the circumferential direction. Hence, in this circumferential consideration of the cross section of the sub-conductor, the insulation only covers a predeterminable section. Thus, the individual sub-conductors have an uncovered (bare) and a covered (insulated) region.

Hence, on the positioning of the sub-conductors of a conductor, only one insulation layer—i.e. one sub-conductor insulation layer—is located between these sub-conductors according to the invention. Bare sides of a sub-conductor lie on insulated sides of the directly adjacent sub-conductors so that there is always a minimum degree of insulation between the individual sub-conductors.

Wrapping the individual sub-conductors with a yarn mixture or yarn, in particular polyester glass fibers or glass fibers, achieves a comparatively higher mechanical loading capacity, for example when inserting the conductors or the winding system into a slot, and comparatively improved partial discharge behavior of a winding system during the operation of a dynamoelectric machine. In addition, herein, additional fixation of this insulation to the one or more sub-conductors can be achieved by wrapping the sub-conductors with a bandage made of a yarn mixture, in particular polyester glass fibers. Herein, the bandage encompasses the entire sub-conductor when viewed in the circumferential direction.

Thus, when viewed in the circumferential direction, a cross section of a sub-conductor has a section with an insulation layer and a section without insulation (bare side). The entire circumference of the sub-conductor is surrounded by a bandage made of polyester glass fibers or glass fibers only. Hence, this bandage lies on both the insulation of the sub-conductor and the bare side of the sub-conductor.

For reasons of strength, the entire conductor, i.e. the entirety of the two or more sub-conductors, can additionally also be surrounded by a bandage made of different tape materials, which then form the main insulation of the conductor.

It is also possible for only the sub-conductors with their partial insulation to be stacked one on top of the other and/or only the entire conductor, inter alia for reasons of strength, to be surrounded by a bandage made of one or different tape materials, for example polyester glass fibers.

Herein, in principle the bandage has either parallel fibers or braided fibers.

Hence, in the case of sub-conductors arranged radially one above the other in a slot of a stator, in each case a bare side of a second sub-conductor lies on an insulation of a first sub-conductor etc. so that there is always a minimum degree of insulation between the individual sub-conductors.

Advantageously, especially in the case of a radial arrangement of these sub-conductors in the slot of a stator or a stator segment and in the case of a rectangular cross section of these sub-conductors, only the upper side or the lower side of the sub-conductors is to be provided with insulation.

The partial insulation of the sub-conductors is in principle provided as tape insulation or varnish insulation.

In cross section, i.e. viewed in the circumferential direction in the slot, the sub-conductors are only partially covered by the sub-conductor insulation. The partial covering is approximately 30 to 70% of the circumference of the sub-conductor—depending the cross-sectional shape of the sub-conductor.

Herein, it is advantageous for this insulation of the partial conductors to be drawn over adjacent edge radii of these covered sides of the sub-conductors. As a result, for example—viewed in the rectangular cross section—one side of the sub-conductor is uncovered, one side is covered and two sides are each partially covered.

The embodiment according to the invention of the sub-conductor insulation reduces the necessary volume of insulation in the slot while simultaneously increasing the copper fill factor or aluminum fill factor, i.e. the electrically available conductor cross section.

In principle, the sub-conductors have a comparatively easily “stackable” cross section; herein especially a substantially rectangular or square cross-sectional shape of the sub-conductors is used. This increases the fill factor of the electrical conductors in the slots of a stator or stator segment.

Herein, the edges of the sub-conductors are advantageously rounded in order to avoid damage to the sub-conductor insulation and/or local field strength maxima.

The sub-conductors of a conductor are arranged radially or vertically and/or horizontally within a slot. Herein, the arrangement of sub-conductors from a slot base in the direction of the air gap of a dynamoelectric machine should be understood to be radial, while a horizontal arrangement of the sub-conductors should be understood to be a substantially tangential arrangement with respect to the air gap.

In the case of sub-conductors with a rectangular cross-sectional shape and hi particular a radial arrangement in a slot with which the narrow sides of the sub-conductors adjoin one another, the partial coverage will be less than it is with an embodiment where the longitudinal sides of a rectangular sub-conductor lie one on top of another.

Axially outside the slot, i.e. in the region of the winding head of a stator or a stator segment, the covering and/or the arrangement of the sub-conductors of the conductor can be embodied as in the slot.

As a result of the winding overhang design, which is embodied in accordance with the type of machine, it is also conceivable to adjust the degree of coverage of the sub-conductors by the insulation and/or the thickness of the bandage, for example made of polyester glass fibers, i.e. the number of layers around the sub-conductor and/or the conductor, in the winding overhang region.

The insulation of the sub-conductors forms a covering, preferably a film, in particular made of polyimide, which is provided with a (hot-melt) adhesive, for example FEP (fluorinated ethylene propylene), and positioned on, in particular bonded to, the sub-conductors.

Herein, the covering, in particular the film, can be embodied as corona-resistant, for example by means of a corresponding incorporation of suitable particles. For example, the particles then constitute mica with a thickness in the range of a few hundredths of a millimeter.

Wrapping the individual sub-conductors with a yarn mixture or yarn, in particular polyester glass fibers or glass fibers, achieves a comparatively higher mechanical loading capacity, for example when inserting the conductors or the winding system in a slot, and a comparatively improved partial discharge behavior of a winding system during the operation of a dynamoelectric machine. In addition, herein additional fixation of this insulation to the one or more sub-conductors can be achieved by wrapping the sub-conductors with a bandage made of a yam mixture, in particular polyester glass fibers. Herein, the bandage encompasses the entire sub-conductor when viewed in the circumferential direction.

This embodiment of the sub-conductors is not restricted to the regions in the slot of the stator or the stator segment but can also be implemented in the winding overhangs of the stator or stator segment.

Depending on the requirements for insulation resistance, the polyester glass fibers have different fiber thicknesses and a different number of fibers. The proportion of the polyester fibers should not exceed 50% of the total weight of the bandage.

For reasons of processing and/or partial discharge behavior, the wrapping should be as smooth and complete as possible. Depending upon the mechanical requirements, the wrapping can be embodied as single-layer or multi-layer wrapping.

The polyester fibers are preferably made of polyethylene terephthalate since such fibers have the necessary temperature resistance during the operation of a dynamoelectric machine and/or the necessary melting characteristics during the production process of the electrical conductors and/or the coll.

Coils of a winding system of a stator or stator segment are formed from one or more such conductors. Herein, the shape of the coil is defined by contouring bodies on which the conductors lie, The inventive design of the conductors obtains a comparatively higher copper fill factor in the slot of a stator or stator segment. However, furthermore, the winding system in the slot of the stator or the stator segment in principle has slot insulation and main insulation with respect to the magnetically conductive main body, i.e. for example the laminated core, and coils of other phases in the slot or winding overhang region.

The invention and advantageous embodiments of the invention are explained in more detail with reference to an exemplary embodiment. The drawings show:

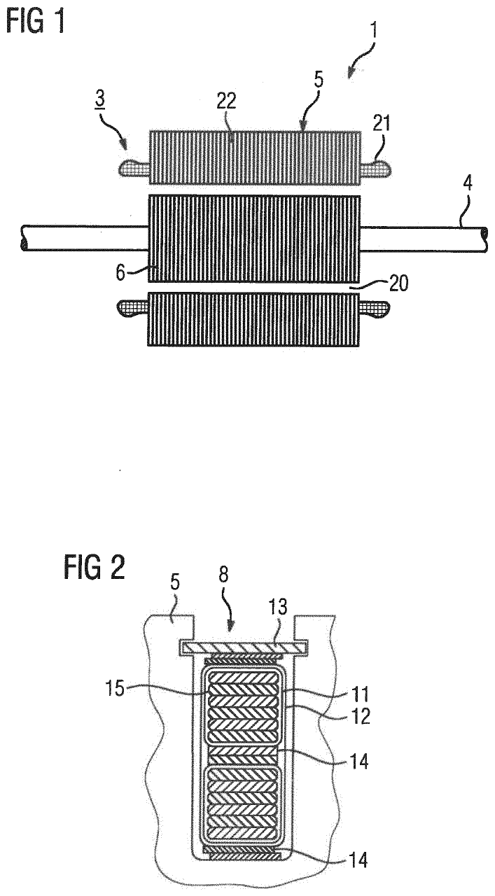

FIG. 1 a schematic representation of a dynamoelectric machine,

FIG. 2 a slot cross section of high-voltage insulation,

FIG. 3 a coil with individual sub-conductors,

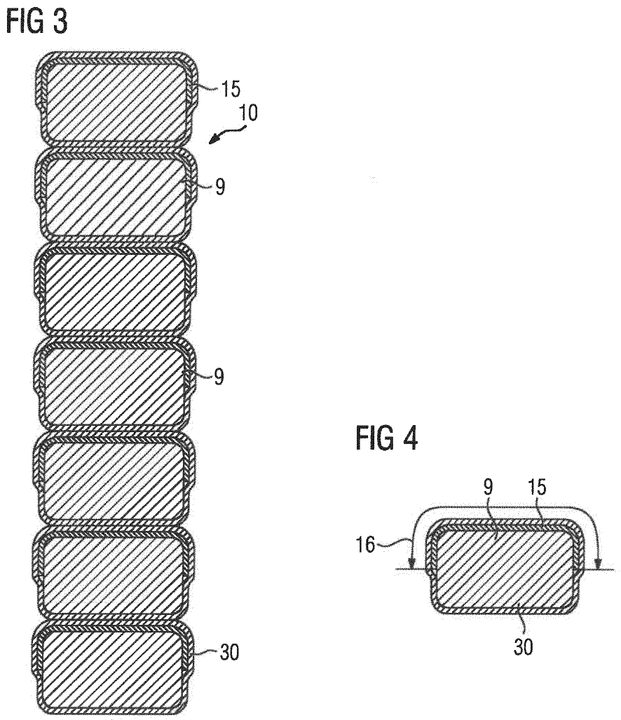

FIG. 4 a detailed depiction of a sub-conductor,

FIG. 5 a further coil with sub-conductors,

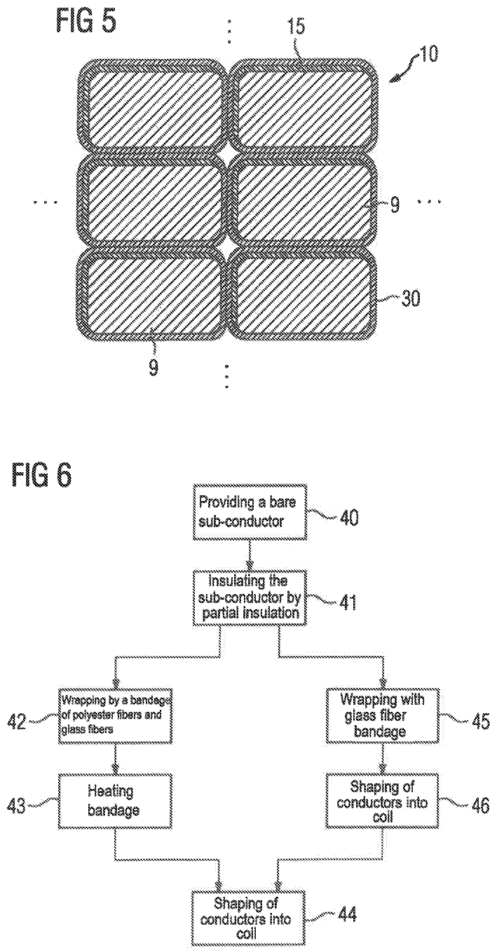

FIG. 6 a flowchart of the production of a coil.

FIG. 1 shows a schematic longitudinal section of a dynamoelectric machine 1 with a stator 5, which is spaced apart from a rotor 6 by an air gap 20, wherein the rotor 6 is connected in a non-rotatable manner to a shaft 4 and mounted rotatably about an axis. When viewed in the circumferential direction, the stator 5 can also be constructed from individual interconnected stator segments.

A winding system 3 located in the stator 5 facing the air gap 20 is arranged in slots 8 (not depicted in further detail) of a magnetically conductive laminated core 22 which forms winding overhangs on the end faces of the stator 5.

A winding system known to date and depicted by way of example in FIG. 2 has two conductors 10 with their sub-conductors 9 in a slot 8, wherein, in this case, a two-layer winding is present. Hence, each layer has a conductor 10 with sub-conductors 9. A slot filler 14 insulates the conductors 10 both from the slot base and between the two conductors 10, and between the uppermost conductor 10 and a slot closing wedge 13.

Herein, each of the sub-conductors 9 has a surrounding sub-conductor insulation 15, which takes over the existing winding insulation and, for high-voltage machines, is to be designed in the range of approximately 80 to 100V. Each conductor 10 is surrounded by a main insulation 11, wherein the entire winding system in this slot 8 is also insulated from the laminated core of the stator 5 by a slot insulation 11.

The structure described endows each sub-conductor insulation 15 with layer thicknesses that are added together over the radial height of the conductor 10 in the slot 8 and thus lead to a reduced copper fill factor of the winding system 3 within the slot 8. This reduces the efficiency of the dynamoelectric machine 1

According to the invention, according to FIG. 3, in the case of a coil 21 having at least one conductor 10 of which the sub-conductors 9 are arranged radially one on top of another, now in each case only one unilateral sub-conductor insulation 15 is applied so that only the necessary minimum degree of insulation is provided between the individual adjacent sub-conductors 9.

FIG. 4 is a more detailed depiction of a substantially rectangular sub-conductor 9, which, viewed in cross section, is partially covered 16 by sub-conductor insulation 15. The partial covering is approximately 30 to 70% of the circumference of the sub-conductor 9—depending upon the cross-sectional shape of the sub-conductors 9.

In other words: in the case of sub-conductors 9 with a rectangular cross-sectional shape and in particular a radial arrangement in the slot 8 with which the narrow sides of sub-conductors 9 adjoin one another, the circumferential partial covering will be less than in the embodiment shown in FIG. 3 where the longitudinal sides of the sub-conductors 9 adjoin one another.

The insulation on the sub-conductors 9 is preferably a film, in particular made of polyimide, which is provided with a (hot-melt) adhesive, for example FEP (fluorinated ethylene propylene), and positioned on, in particular bonded to, the sub-conductors.

Wrapping the individual sub-conductors 9 with a yarn mixture or yarn, in particular polyester glass fibers or glass fibers, achieves a comparatively higher mechanical loading capacity, for example when inserting the conductors or the winding system in a slot 8 and a comparatively improved partial discharge behavior of a winding system 3 during the operation of a dynamoelectric machine 1.

In addition, herein additional fixation of this insulation to the one or more sub-conductors 9 can be achieved by wrapping the sub-conductors 9 with a bandage 30 made of a yarn mixture, in particular polyester glass fibers. Herein, the bandage 30 encompasses the entire sub-conductor 9 when viewed in the circumferential direction. This also achieves an additional fixation of the insulation to the sub-conductors 9 as shown in FIG. 3 and FIG. 4.

When viewed in the circumferential direction, the bandage 30 made of polyester fibers and/or glass fibers encompasses the entire sub-conductor 9. The bandage 30 is advantageously single-layer only in order not to impair the fill factor in the slot 8.

This embodiment of the sub-conductors 9 is not restricted to the regions in the slot 8 of the stator 5 or stator segment but can also be implemented in the winding overhangs of the winding system 3 of the stator 5 or stator segment.

Advantageously, the sub-conductors 9 have a substantially rectangular or square cross-sectional area. Herein, the edges of the sub-conductors 9 are rounded in order to avoid damage to the sub-conductor insulation 15. Within a slot 8 of a stator 5 of a dynamoelectric machine 1, the sub-conductors 9 of a conductor 10 are arranged radially or vertically and/or horizontally.

FIG. 5 shows, in a further embodiment, a conductor 10 with horizontally and vertically arranged sub-conductors 9. Herein—viewed in cross section—two sides of the rectangular sub-conductor 9 are provided almost completely or completely with sub-conductor insulation 15. According to the invention, the sub-conductors 9 adjacent to this sub-conductor insulation 15 do not have any sub-conductor insulation 15 on these sides. However,—as depicted for example in FIG. 3 or FIG. 4—it is possible for the adjacent edges of the respective sub-conductor 9 to be covered.

Depending on the requirements for insulation resistance, the polyester glass fibers of the bandage 30 have different fiber thicknesses and a different number of fibers. The proportion of the polyester fibers should not exceed 50% of the total weight of the bandage 30.

The wrapping of the sub-conductors 9 and/or the conductor 10 by the bandage 30 should be as smooth and complete as possible. Depending upon the mechanical requirements, the wrapping can be embodied as single-layer or multi-layer wrapping.

The polyester fibers are preferably made of polyethylene terephthalate since these fibers have the necessary temperature resistance during the operation of a dynamoelectric machine and/or the necessary melting characteristics during the production process of the electrical conductors 10 and/or the coil 21 during the operation of a dynamoelectric machine 1. Herein, due to the low alkali content, the glass fibers are preferably made of E-glass.

The inventive concept for increasing the fill factor of the electrical conductors 10 in a slot 8 by partial sub-conductor insulation is suitable for one-layer, two-layer or multi-layer windings in the stator 5 or stator segment of a dynamoelectric machine 1.

As shown in the schematic representation in FIG. 6, the production method for a coil 21 now has the following steps:

Providing 40 a bare sub-conductor 9. This sub-conductor 9 is insulated by partial insulation according to step 41 with a predeterminable covering 16. Subsequent wrapping 42 by means of a bandage 30 causes the insulation 15 to be additionally wrapped on the sub-conductor 9. In the step 43, the fiber mixture made of polyester fibers and glass fibers is heated so that the polyester melts and thus the glass fibers are bonded to the existing substrate, i.e, the insulation layer 15 and/or the surface of the bare sub-conductor 9. In the step 44, the conductors 10 are shaped into a coil 21 by using contouring bodies against which the conductors 10 rest for shaping the coil 21. These sub-conductors 9 are then impregnated with the main insulation 11.

Alternatively, the coil 21 shown in FIG. 6 can also be produced in the following manner:

Providing 40 a bare sub-conductor 9, insulating these sub-conductors 9 by a partial insulation with a predeterminable covering 16 according to step 41, wrapping these sub-conductors 9 with a glass fiber bandage according to step 45, then impregnating the wrapped sub-conductors 9 with resin or varnish and curing according to step 46 resulting in bonding. These conductors 10 which are finally produced according to step 46 are now also shaped into a coil 21 according to step 44 in that the shaping of this coil 21 is performed using contouring bodies against which the conductors 10 rest.

Such coils 21 are used in winding systems 3 of dynamoelectric machines 1, in particular high-voltage machines, for example in the field of wind- power generators. The comparatively increased minimum copper or aluminum fill factor of the conductors 10 in the slot 8 of a stator 5 or stator segment increases the efficiency of such a dynamoelectric machine 1.

1.-12. (canceled)

13. An electrical conductor for a winding system of a dynamoelectric machine, said electric conductor comprising:
a plurality of sub-conductors;
a single insulation layer disposed on one of adjacent ones of the sub-conductors at a side facing the other one of the adjacent ones of the sub-conductors to insulate the adjacent sub-conductors from each other, said insulation layer embodied as a film bonded to the one sub-conductor or as a varnish insulation; and
a bandage surrounding each of the sub-conductors and made of polyester fibers and glass fibers or of glass fibers only to enhance a mechanical loading capacity, said bandage wrapped to the sub-conductor such as to cause the insulation layer to be additionally wrapped on the sub-conductor.

14. The electrical conductor of claim 13, wherein the sub-conductors have each a substantially rectangular or square cross section.

15. The electrical conductor of claim 13, wherein, when viewed in cross section, the insulation layer is configured to cover the side of the sub-conductor and is sized to extend over adjacent edge radii of the side.

16. The electrical conductor of claim 13, wherein, when viewed in cross section, the insulation layer is configured to provide a covering of the sub-conductor between 30 and 70%.

17. A coil of a winding system of a dynamoelectric machine, said coil comprising an electrical conductor comprising a plurality of sub-conductors, a single insulation layer disposed on one of adjacent ones of the sub-conductors at a side facing the other one of the adjacent ones of the sub-conductors to insulate the adjacent sub-conductors from each other, said insulation layer embodied as a film bonded to the one sub-conductor or as a varnish insulation, and a bandage surrounding each of the sub-conductors and made of polyester fibers and glass fibers or of glass fibers only to enhance a mechanical loading capacity, said bandage wrapped to the sub-conductor such as to cause the insulation layer to be additionally wrapped on the sub-conductor.

18. The coil of claim 17, wherein the sub-conductors have each a substantially rectangular or square cross section.

19. The coil of claim 17, wherein, when viewed in cross section, the insulation layer is configured to cover the side of the sub-conductor and is sized to extend over adjacent edge radii of the side.

20. The coil of claim 17, wherein, when viewed in cross section, the insulation layer is configured to provide a covering of the sub-conductor between 30 and 70%.

21. A stator or stator segment of a dynamoelectric machine, comprising a winding system arranged in slots of the stator or stator segment and including individual electrically mutually contactable coils in each phase, each said coil comprising an electrical conductor comprising a plurality of sub-conductors, a single insulation layer disposed on one of adjacent ones of the sub-conductors at a side facing the other one of the adjacent ones of the sub-conductors to insulate the adjacent sub-conductors from each other, said insulation layer embodied as a film bonded to the one sub-conductor or as a varnish insulation, and a bandage surrounding each of the sub-conductors and made of polyester fibers and glass fibers or of glass fibers only to enhance a mechanical loading capacity, said bandage wrapped to the sub-conductor such as to cause the insulation layer to be additionally wrapped on the sub-conductor.

22. The stator or stator segment of claim 21, wherein the sub-conductors of the electrical conductor are arranged radially and/or horizontally at least in the slots of the stator.

23. The stator or stator segment of claim 21, wherein the sub-conductors have each a substantially rectangular or square cross section.

24. The stator or stator segment of claim 21, wherein, when viewed in cross section, the insulation layer is configured to cover the side of the sub-conductor and is sized to extend over adjacent edge radii of the side.

25. The stator or stator segment of claim 21, wherein, when viewed in cross section, the insulation layer is configured to provide a covering of the sub-conductor between 30 and 70%.

26. A dynamoelectric machine, in particular a high-voltage machine, said dynamoelectric machine comprising a stator or a stator segment comprising a winding system arranged in slots of the stator or stator segment and including individual electrically mutually contactable coils in each phase, each said coil comprising an electrical conductor comprising a plurality of sub-conductors, a single insulation layer disposed on one of adjacent ones of the sub-conductors at a side facing the other one of the adjacent ones of the sub-conductors to insulate the adjacent sub-conductors from each other, said insulation layer embodied as a film bonded to the one sub-conductor or as a varnish insulation, and a bandage surrounding each of the sub-conductors and made of polyester fibers and glass fibers or of glass fibers only to enhance a mechanical loading capacity, said bandage wrapped to the sub-conductor such as to cause the insulation layer to be additionally wrapped on the sub-conductor.

27. The dynamoelectric machine of claim 26, wherein the sub-conductors of the electrical conductor are arranged radially and/or horizontally at least in the slots of the stator.

28. A method for producing an electrical conductor for a winding system of a dynamoelectric machine, said method comprising:
partially applying to bare sub-conductors an insulation layer in the form of a film bonded to the sub-conductor or a varnish insulation, in particular with a predeterminable covering of the sub-conductor of 30 to 70% when viewed in a circumferential direction;
arranging the sub-conductors such that only the insulation layer is disposed between adjacent ones of the sub-conductors to insulate the adjacent sub-conductors from each other;
surrounding each sub-conductor by a bandage made of polyester fibers and glass fibers to enhance a mechanical loading capacity, such that the bandage is wrapped so as to cause the insulation layer to be additionally wrapped on the sub-conductor; and
heating a fiber mixture of the bandage made of polyester fibers and glass fibers so as to melt the polyester fibers, thereby bonding the glass fibers to the insulation layer or a surface of the bare sub-conductor.

29. A method for producing a coil from electrical conductors produced by a method as set forth in claim 28, said method for producing the coil comprising resting the conductors against contouring bodies to shape the coil.

30. A method for producing an electrical conductor for a winding system of a dynamoelectric machine, said method comprising:
partially applying to bare sub-conductors an insulation layer in the form of a film bonded to the sub-conductor or a varnish insulation, in particular with a predeterminable covering of the sub-conductor of 30 to 70% when viewed in a circumferential direction;
arranging the sub-conductors such that only the insulation layer is disposed between adjacent ones of the sub-conductors to insulate the adjacent sub-conductors from each other;
wrapping each sub-conductor by a glass fiber bandage to enhance a mechanical loading capacity;
impregnating the sub-conductors with resin or varnish; and
allowing the resin or varnish to cure.

31. A method for producing a coil from electrical conductors produced by a method as set forth in claim 30, said method for producing the coil comprising resting the conductors against contouring bodies to shape the coil.

32. A method for producing a winding system of a stator or stator segment, said method comprising:
providing a magnetically conductive main body, in particular a laminated core, with substantially axially extending slots;
inserting prefabricated coils or a conductor as set forth in claim 13 into the slots in accordance with a predeterminable winding scheme in order to obtain a winding system of the stator or the stator segment; and
impregnating the winding system in the slots.
